(19) United States
(12) Patent Application Publication
(10) Pub. No.: US 2011/0189961 A1
(43) Pub. Date: Aug. 4, 2011

(54) DATA TRANSMISSION METHOD AND APPARATUS BASED ON MOTION IDENTIFICATION

(75) Inventors: Lin XIE, Nanjing (CN); Le DU, Nanjing (CN); Haoliang ZHU, Nanjing (CN)

(73) Assignees: SAMSUNG ELECTRONICS CO. LTD., Suwon-si (KR); SAMSUNG ELECTRONICS (CHINA) R&D CENTER, Nanjing (CN)

(21) Appl. No.: 13/013,058

(22) Filed: Jan. 25, 2011

(30) Foreign Application Priority Data
Feb. 4, 2010 (CN) 201010108887.8

(51) Int. Cl. H04B 17/00

(52) U.S. Cl. 455/67.11

(57) ABSTRACT

A data transmission method and apparatus based on motion identification are disclosed. The method includes detecting and identifying a change of a position status of a data transmission apparatus, detecting, by the data transmission apparatus, a target apparatus when the change of the position status is determined to be a predefined motion, and establishing, by the data transmission apparatus, a connection with the target apparatus and performing, by the data transmission apparatus, a data transmission, if the target apparatus is detected. The data transmission method does not operate through an interface, but can trigger a data transmission apparatus to detect a target apparatus and to perform a data transmission by only identifying a motion of the data transmission apparatus. Thus, the operation of data transmission can be simplified, and a user-friendly operation method can be achieved.

### PRIORITY

This application claims the benefit under 35 C. §119(a) of a Chinese patent application filed in the State Intellectual Property Office of CHINA on Feb. 4, 2010 and assigned Serial No. 201010108887.8, the entire disclosure of which is hereby incorporated by reference.

### JOINT RESEARCH AGREEMENT

The presently claimed invention was made by or on behalf of the below listed parties to a joint research agreement. The joint research agreement was in effect on or before the date the claimed invention was made and the claimed invention was made as a result of activities undertaken within the scope of the joint research agreement. The parties to the joint research agreement are 1) SAMSUNG ELECTRONICS CO., LTD., and 2) SAMSUNG ELECTRONICS (CHINA) R&D CENTER.

### BACKGROUND OF THE INVENTION

1. Field of the Invention

The present invention relates to a data transmission method. More particularly, the present invention relates to a method of triggering data transmission through a motion.

2. Description of the Related Art

A wireless data reception and sending method of the conventional art mainly adopts a manner in which a user selects a data reception object through an interface and accomplishes data transmission by using communication protocols such as Bluetooth, infrared waves, a wireless network, etc.

Some short distance wireless transmission physical methods have high directionality characteristics. In addition to the infrared waves mentioned above, for example, a millimeter wave of 60 gigahertz (GHz) has been widely used in control or transmission (such as a TeleVision (TV) remote controller, a wireless handle of a game machine). A typical example of a wireless handle of a game machine is the Wii remote controller made by Nintendo Co., Ltd, which is a device for operating a video game by using high directionality characteristics of a remote control signal.

In addition to selecting a data reception object through an interface, the above conventional transmission method also needs to set various transmission parameters through the interface before a sending key is finally selected for sending, which may bring inconvenience to the operation.

Recently, a technology for setting parameters of data transmission by identifying a motion has been proposed. For example, US Patent Application Publication No. 2008/0195735 discloses that data flow, transmission rate, and the like are set by identifying a motion, so that an operation of parameter setting becomes more humanized. However, the parameter setting performed by identifying a motion therein is on the premise of that data transmission has been triggered.

### SUMMARY OF THE INVENTION

An aspect of the present invention is to address at least the above-mentioned problems and/or disadvantages and to provide at least the advantages described below. Accordingly, an aspect of the present invention is to provide a method of triggering data transmission through motion identification. The method is not operated through an interface, but can trigger a data transmission apparatus to detect a target apparatus and to perform data transmission only by identifying a motion of the data transmission apparatus. Thus, the operation of data transmission can be simplified, and a user-friendly operation method can be achieved.

According to an aspect of the present invention, a data transmission method based on motion identification is provided. The method includes sensing and identifying a change of a position status of a data transmission apparatus, detecting, by the data transmission apparatus, a target apparatus, when the change of the position status is identified as a predefined motion, and establishing, by the data transmission apparatus, a connection with the target apparatus and performing, by the data transmission apparatus, a data transmission, if the target apparatus is detected.

In the data transmission method, the predefined motion may be a data sending triggering motion or a data reception triggering motion.

In the data transmission method, the data sending triggering motion may be to take up the transmission apparatus as a whole to draw a circle clockwise, and the data reception triggering motion may be to take up the transmission apparatus as a whole to draw a circle counterclockwise.

In the data transmission method, the data sending triggering motion may change the data transmission apparatus from a substantially vertical orientation into a substantially horizontal orientation, and the data reception triggering motion may change the data transmission apparatus from an inverted substantially vertical orientation into the substantially horizontal orientation.

In the data transmission method, the data sending triggering motion may be to horizontally swing the transmission apparatus as a whole in a first direction, and the data reception triggering motion may be to horizontally swing the transmission apparatus as a whole in a second direction opposite to the first direction.

In the data transmission method, the target apparatus detection unit may detect the target apparatus by broadcasting an apparatus identification request toward specific directions and by receiving a signal fed back from the target apparatus.

In the data transmission method, the apparatus identification request may include a wireless signal having a high directionality.

In the data transmission method, the apparatus identification request may be an Infrared Data Association (IrDA) infrared signal or a millimeter wave signal of 60 gigahertz (GHz).

In the data transmission method, when the data transmission apparatus receives apparatus identification requests of other data transmission apparatuses, the data transmission apparatus may send a feedback signal to the other data transmission apparatuses.

According to another aspect of the present invention, a data transmission apparatus based on motion identification is provided. The apparatus includes a motion sensing and identification unit for detecting and identifying a change of a position status of the data transmission apparatus, a target apparatus detection unit for detecting a target apparatus, when the change of the position status is identified as a predefined motion, and a data transmission unit for establishing a connection with the target apparatus and for performing a data transmission, if the target apparatus detection unit detects the target apparatus.

The data transmission method and apparatus according to the present application do not operate through an interface, but can trigger a data transmission apparatus to detect a target apparatus and to perform data transmission only by identifying a motion of the data transmission apparatus. Thus, the operation of data transmission can be simplified, and a user-friendly operation method can be achieved.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, of which:

FIG. 1 is a block diagram of a data transmission apparatus according to an exemplary embodiment of the present invention;

FIG. 2 is a flowchart of a data transmission method according to an exemplary embodiment of the present invention;

FIG. 3 is a view of a rectangular coordinate defined for identifying a motion sense according to an exemplary embodiment of the present invention;

FIG. 4A is a schematic view for illustrating a data sending triggering motion according to an exemplary embodiment of the present invention;

FIG. 4B is a schematic view for illustrating a data reception triggering motion according to an exemplary embodiment of the present invention;

FIGS. 5A, 5B, and 5C are views for exemplarily illustrating sampling data arrays according to an exemplary embodiment of the present invention;

FIG. 6 is a schematic view for explaining target detection by a target apparatus detection unit according to an exemplary embodiment of the present invention;

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

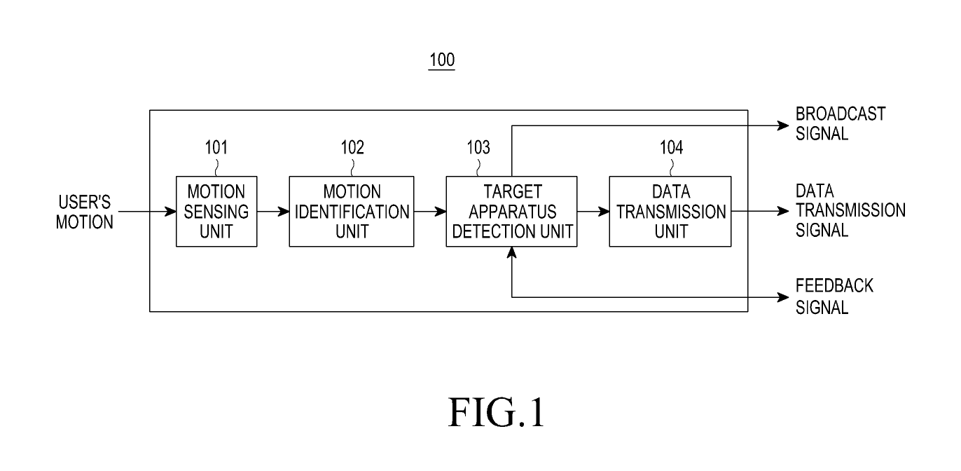

FIG. 1 is a block diagram of a data transmission apparatus according to an exemplary embodiment of the present invention.

Referring to FIG. 1, the data transmission apparatus 100 may be, for example, a mobile phone, a remote controller, or another hand-held electronic apparatus. For convenience of description, FIG. 1 only shows a motion sensing unit 101, a motion identification unit 102, a target apparatus detection unit 103, and a data transmission unit 104 in the data transmission apparatus 100 related to data transmission.

The motion sensing unit 101 detects a motion of the data transmission apparatus 100 by using a 3-axis acceleration sensor, that is, detects a change of the position status of the data transmission apparatus 100.

The motion identification unit 102 determines whether the motion of the data transmission apparatus 100 is a data sending triggering motion or a data reception triggering motion which is predefined, according to a detected result of the motion of the data transmission apparatus 100 by the motion sensing unit 101.

The target apparatus detection unit 103 detects a target apparatus in a visible range within a predetermined period of time, by using an Infrared Data Association (IrDA) infrared technology or other wireless signal technology having a high directionality. Also, the data transmission apparatus 100, which is a target apparatus, is detected by other apparatuses, and sends a detection feedback signal to another party when determining that the data transmission apparatus 100 can be matched with the another party to perform data transmission.

The data transmission unit 104 establishes connection with the target apparatus and performs data transmission, by using an IrDA infrared technology, a millimeter wave of 60 gigahertz (GHz), or other wireless signal technology having a high directionality.

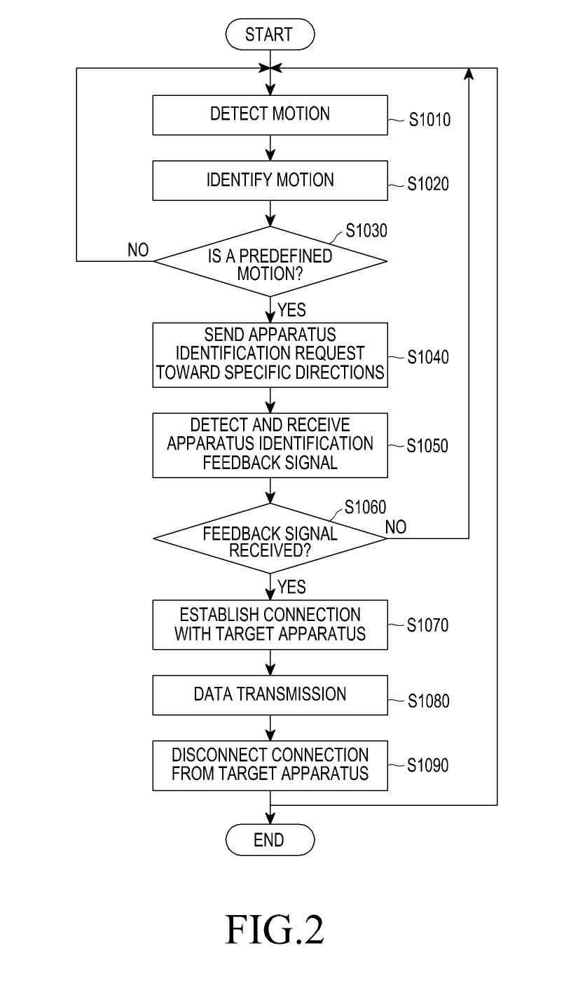

FIG. 2 is a flowchart of a data transmission method according to an exemplary embodiment of the present invention.

Referring to FIG. 2, in step S1010, the motion sensing unit 101 detects a motion of the data transmission apparatus 100 by using a 3-axis acceleration sensor.

Next, in step S1020, the motion identification unit 102 determines whether the motion of the data transmission apparatus 100 is a data sending triggering motion or a data reception triggering motion which is predefined, according to a detected result of the motion of the data transmission apparatus 100 by the motion sensing unit 101.

Subsequently, in step S1030, the motion identification unit 102 makes a determination according to the identification result. If the motion identification unit 102 determines that the motion is not a data sending triggering motion or a data reception triggering motion which is predefined (“N” in step S1030), the data transmission method abandons the data transmission, and returns to step S1010, in which the motion sensing unit 101 continues to detect a motion of the data transmission apparatus 100.

In step S1030, if the motion identification unit 102 determines that the motion is a data sending triggering motion or a data reception triggering motion which is predefined (“Y” in step S1030), then in step S1040 the target apparatus detection unit 103 sends an apparatus identification request toward specific directions within a predetermined period of time, so as to detect a target apparatus.

Next, in step S1050, the target apparatus detection unit 103 detects and receives an apparatus identification feedback signal from the target apparatus within a predetermined period of time.

Next, in step S1060, the target apparatus detection unit 103 determines whether a feedback signal is received within the predetermined period of time. If it is determined that the feedback signal is not received within the predetermined period of time (“N” in step S1060), the data transmission method returns to step S1010, in which the motion sensing unit 101 continues to detect a motion of the data transmission apparatus 100.

If the feedback signal is received within the predetermined period of time (“Y” in step S1060), then in step S1070 the data transmission unit 104 establishes a connection with the target apparatus.

Next, in step S1080, the data transmission unit 104 performs a data transmission with the target apparatus.

Next, in step S1090, the data transmission unit 104 disconnects from the target apparatus after the data transmission is finished.

Hereinafter, an exemplary implementation of the data transmission method is described. In this example, data transmission apparatus 100, which is a data sending party, actively triggers a data transmission and sends data to a target apparatus after detecting the target apparatus.

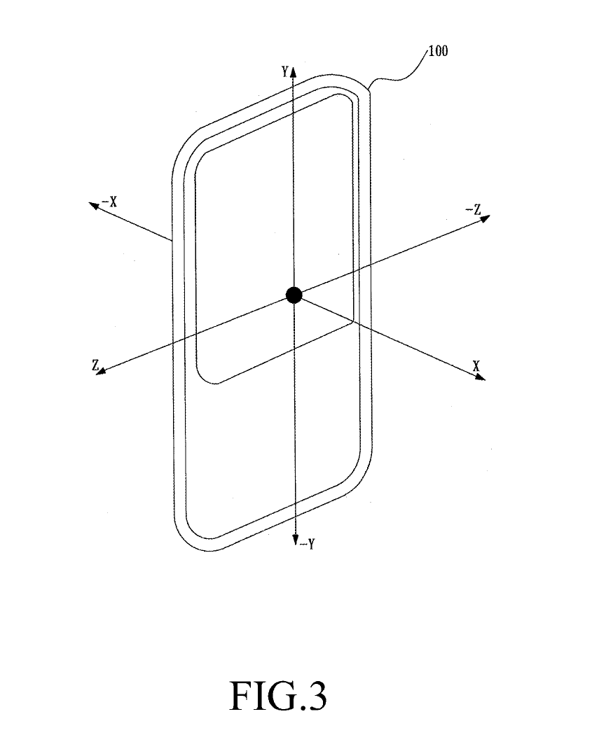

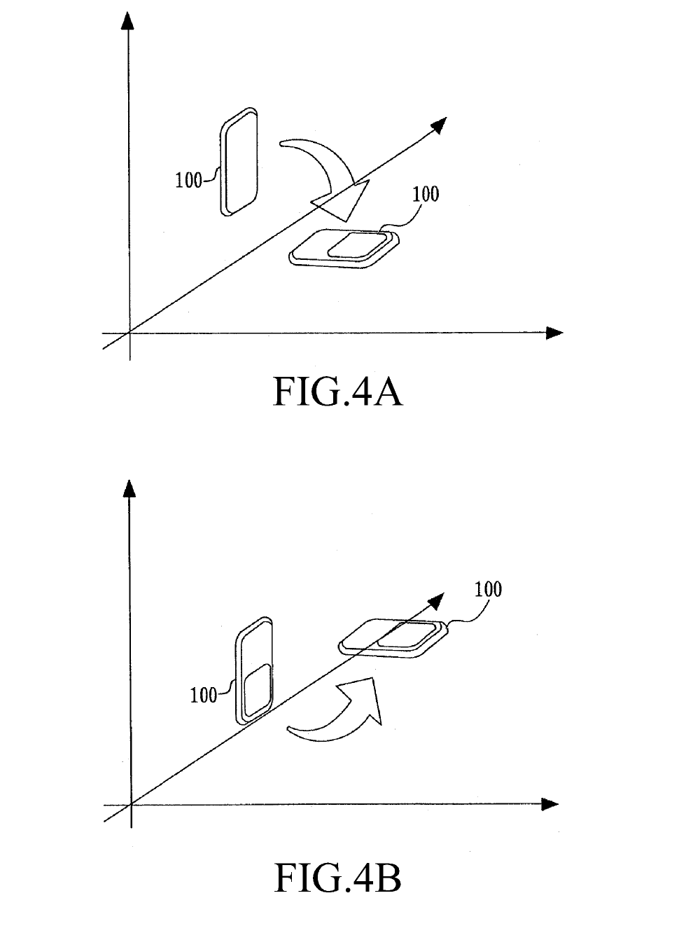

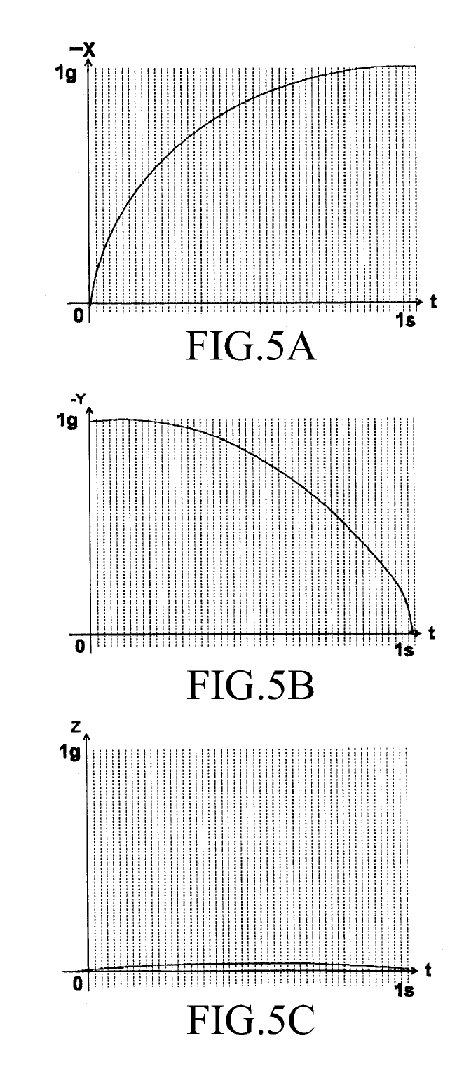

The initial setting of data transmission apparatus 100 is first described by using FIGS. 3, 4A, 4B, 5A, 5B and 5C, wherein FIG. 3 is a view of a rectangular coordinate system defined for identifying a motion sense according to an exemplary embodiment of the present invention, FIG. 4A is a schematic view illustrating a data sending triggering motion according to an exemplary embodiment of the present invention, FIG. 4B is a schematic view illustrating a data reception triggering motion according to an exemplary embodiment of the present invention, and FIGS. 5A, 5B, and 5C are views for exemplarily illustrating sampling data arrays.

Referring to FIG. 3, the rectangular coordinates of a 3-axis acceleration sensor in the motion sensing unit 101 with respect to the data transmission apparatus 100 are defined. Furthermore, for the purposes of this example, a data sending triggering motion as shown in FIG. 4A and a data reception triggering motion as shown in FIG. 4B are predefined as two predefined motion types. That is, the data sending triggering motion changes the data transmission apparatus 100 from a substantially vertical orientation into a substantially horizontal orientation, while the data reception triggering motion changes the data transmission apparatus 100 from an inverted substantially vertical orientation into the substantially horizontal orientation.

Gravity accelerations in three coordinate directions are sampled with respect to the above two predefined motion types, respectively, and 50 sampling points are extracted during the whole motion which may be divided into three stages of “rest-motion-rest”. Acceleration sampling data of the data sending triggering motion at respective coordinate axes are written into arrays. In the exemplary embodiment, the arrays may preferably be X1[50], Y1[50], and Z1[50], respectively. FIGS. 5A, 5B, and 5C are exemplary representations of sampling data arrays X1[50], Y1[50], and Z1[50] in the coordinate graph, respectively. In a similar way, acceleration sampling data of the predefined data reception triggering motion in respective coordinate axes are written into arrays x1[50], y1[50], and z1[50] (the representations thereof are omitted).

The above sampling process is repeated. In the exemplary embodiment, the process may preferably be repeated 10 times, and corresponding sampling data are sequentially written into X1[50], Y1[50], Z1[50], X2[50], Y2[50], Z2[50], . . . , X10[50], Y10[50], Z10[50], and into x1[50], y1[50], z1[50], x2[50], y2[50], z2[50], . . . , x10[50], y10[50], z10[50]. Thereafter, a maximum and minimum of the 10 sampling data for each sampling point of the X axis among the 50 sampling points of the predefined data sending triggering motion are written into arrays. In the exemplary embodiment, the arrays may preferably be Max_X[50] and Min_X[50], respectively. In a similar way, a maximum and minimum of the 10 sampling data for each sampling point of the Y axis and Z axis among the 50 sampling points of the predefined data sending triggering motion are written into arrays Max_Y[50], Min_Y[50], Max_Z[50] and Min_Z[50], respectively. In a similar way, the maximum data and minimum data array sets max_x[50], min_x[50], max_y[50], min_y[50], max_z[50], and min_z[50] corresponding to the predefined data reception triggering motion are obtained. These maximum data and minimum data array sets are used in a subsequent motion identification process of the data transmission apparatus 100.

Next, exemplary implementations of the respective steps in the data transmission method shown in FIG. 2 are described.

First, when the data transmission apparatus 100 detects a motion, the 3-axis acceleration sensor of the motion sensing unit 101 starts sampling, and obtains 50 sampling points during the whole motion. Acceleration sampling data of respective coordinate axes are written into arrays X1[50], Y1[50], and Z1[50], respectively. Thus, step S1010 in FIG. 2 is particularly implemented.

The motion identification unit 102 compares each of the 50 sampling points with a corresponding sampling point of a predefined sending motion. When the sampling points fall within a predetermined range, such that Min_X[i]≦X[i]≦Max_X[i] (i=1, 2, . . . , 49, 50), Min_Y[i]≦Y[i]≦Max_Y[i] (i=1, 2, . . . , 49, 50) and Min_Z[i]≦Z[i]≦Max_Z[i] (i=1, 2, . . . , 49, 50) are satisfied, this motion is identified as a data sending triggering motion (“Y” in step S1030). When the above conditions are not satisfied, the sampling data of this motion are discarded, and data transmission is abandoned (“N” in step S1030). So far, steps S1020 and S1030 in FIG. 2 are particularly implemented.

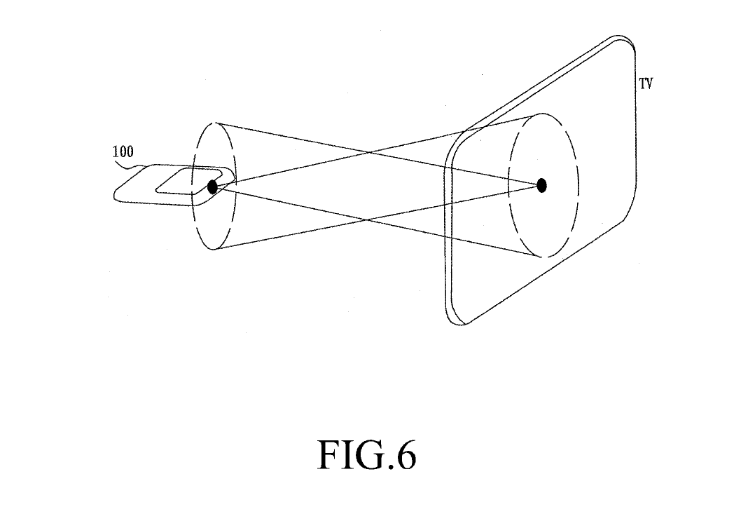

If the motion of the data transmission apparatus 100 is identified as a data sending triggering motion (“Y” in step S1030), the target apparatus detection unit 103 detects and identifies a target apparatus by using an IrDA infrared technology or other wireless signal technology having a high directionality, which is described by using FIG. 6. FIG. 6 is a schematic view for explaining target detection by a target apparatus detection unit according to an exemplary embodiment of the present invention.

Referring to FIG. 6, it is assumed, for example, that the target apparatus is a TeleVision (TV). First, the target apparatus detection unit 103 uses an IrDA apparatus installed therein, and broadcasts an IrDA detection signal toward a specific direction within a predetermined period of time through an IrDA sending port of the IrDA apparatus, so as to detect a target apparatus within a visible range. For example, the IrDA 1.0 protocol defines that the visible range is “a transmission distance<1 meter, and a beam solid angle<30 degrees.” Meanwhile, the target apparatus detection unit 103 detects and receives an apparatus identification feedback signal from the target apparatus within a predetermined period of time, through an IrDA reception port. So far, steps S1040 and S1050 in FIG. 2 are particularly implemented.

When the IrDA reception port detects and receives the apparatus identification feedback signal from the target apparatus within the predetermined period of time (such as one second), it is determined that the target apparatus is detected, and the IrDA sending port stops broadcasting and parses a logical address of the target apparatus (“Y” in step S1060). If the IrDA reception port does not detect and receive the apparatus identification feedback signal from the target apparatus within the predetermined period of time, it is determined that there is no target apparatus in the visible range (“N” in step S1060).

The data transmission unit 104 establishes a connection with the target apparatus according to the logical address of the target apparatus, and exchanges data with the target apparatus. In more detail, the data transmission unit 104 sends a connection request to the target apparatus. Then the target apparatus accepts this connection request, and sends a response frame of an unnumbered reply including an ending bit, which indicates that the connection request has been accepted. Next, the data transmission unit 104 receives this reply, and the connection is successfully established. So far, step S1070 in FIG. 2 is particularly implemented.

Next, the data transmission starts. So far, step S1080 in FIG. 2 is particularly implemented.

When the data transmission is finished, the data transmission unit 104 sends a disconnection request to the target apparatus, then the target apparatus returns an acknowledge frame of an unnumbered reply including an ending bit. Next, the data transmission unit 104 receives this reply, and disconnects the connection. So far, step S1090 in FIG. 2 is particularly implemented.

In the above example, a case is described wherein the data transmission apparatus 100 (which is a data sending party) actively triggers a data transmission, and performs the data transmission after detecting and identifying a target apparatus which is a data reception party. In a similar way, such a case may be derived wherein the data reception party actively triggers a data transmission, and performs the data transmission after detecting and identifying a target apparatus which is a data sending party.

In this example in which the data reception party actively triggers data transmission, it is assumed that the data reception party is a data transmission apparatus 100′, and the structure of the data transmission apparatus 100′ is the same as that of the data transmission apparatus 100. That is, the structures of the motion sensing unit 101′, the motion identification unit 102′, the target apparatus detection unit 103′ and the data transmission unit 104′ in the data transmission apparatus 100′ are the same as those of the motion sensing unit 101, the motion identification unit 102, the target apparatus detection unit 103 and the data transmission unit 104 in the data transmission apparatus 100. Different reference signs are used to distinguish the data transmission apparatus 100′ from the data transmission apparatus 100′ which is a data sending party.

Since the initial setting of the data transmission apparatus 100′ is the same as the initial setting of the data transmission apparatus 100, the initial setting of the data transmission apparatus 100′ is omitted. In the initial setting of the data transmission apparatus 100′, arrays X1′[50], Y1′[50], Z1′[50], X2′[50], Y2′[50], Z2′[50], . . . , X10′[50], Y10′[50], Z10′[50], x1′[50], y1′[50], z1′[50], x2′[50], y2′[50], z2′[50], . . . , x10′[50], y10′[50], z10′[50], Max_X′[50], Min_X′[50], max_x′[50], min_x′[50], Max_Y′[50], Min_Y′[50], Max_Z′[50], Min_Z′[50], max_y′[50], min_y′[50], max_z′[50], and min_z′[50] are similarly implemented.

The detailed implementation of the data transmission method as shown in FIG. 2 is substantially the same as in the case where the data transmission apparatus 100 actively triggers the data transmission. The differences are as follows:

In step S1020, the motion identification unit 102′ of the data transmission apparatus 100′ which is a reception party compares each of the 50 sampling points with a corresponding sampling point of a predefined reception motion. When the sampling points are determined to fall in a predetermined range such that min_x′ [i]≦x′ [i]≦max_x′ [i] (i=1, 2, . . . , 49, 50), min_y′ [i]≦y′ [i]≦max_y′ [i] (i=1, 2, . . . , 49, 50) and min_z′ [i]≦z′ [i]≦max_z′ [i] (i=1, 2, . . . , 49, 50) are satisfied, this motion may then be identified as a data reception triggering motion (“Y” in step S1030). When the above conditions are not satisfied, the sampling data of this motion are discarded (“N” in step S1030).

In steps S1040 and S1050, the operation of the target apparatus detection unit 103′ of the data transmission apparatus 100′ which is a reception party is the same as that of the target apparatus detection unit 103 of the data transmission apparatus 100 which is a sending party. The only difference lies in that the identified target apparatus is a sending party apparatus, rather than a reception party apparatus. That is, during this process, the sending party apparatus located in the visible range of the reception party may send an apparatus identification feedback signal to the data transmission apparatus 100′.

In steps S1070 and S1090, the operations of the reception party and the sending party are the same as those in this exemplary embodiment. The only difference lies in that the apparatus, which actively establishes the data transmission connection and actively disconnects the connection after the data exchange is finished, is the data transmission apparatus 100′, rather than a sending party apparatus.

In step S1080, the data transmission apparatus 100′ acts as a data reception party to perform the data transmission with the sending party apparatus.

An exemplary embodiment of the present invention is described as above.

As described above, the data transmission apparatus and data transmission method according to an exemplary embodiment of the present invention detect and identify a change of a position status of the data transmission apparatus, trigger a data transmission initiation, and then automatically detect a target apparatus and perform the data transmission. Thus, the selection of a target apparatus or the initiation of a data transmission through a menu can be avoided, so that the operation of the data transmission can be simplified, thereby achieving the effect of improving the user's experience.

In addition, in the example of the current embodiment, the target apparatus is the data transmission apparatus according to an exemplary embodiment of the present invention, but the present invention is not limited to this. The target apparatus may also be an apparatus which can feed back target identification and perform a data transmission with the data transmission apparatus according to the present invention.

Furthermore, in the current exemplary embodiment, the data sending triggering motion is predefined to change the data transmission apparatus 100 from an upright status into a lying status, and the data reception triggering motion is predefined to change the data transmission apparatus 100 from an inverted status into a lying status, but the present invention is not limited to this. For example, the data sending triggering motion may also be predefined to include using the transmission apparatus 100 as a whole to describe a circle in a predetermined direction, and the data reception triggering motion may also be predefined to include using the transmission apparatus 100 as a whole to describe a circle in a direction opposite to the predetermined direction. Then for example, the data sending triggering motion may also be predefined to horizontally swing the transmission apparatus 100 as a whole in a predetermined direction, and the data reception triggering motion may also be predefined to horizontally swing the transmission apparatus 100 as a whole in a direction opposite to the predetermined direction. The data sending triggering motion and the data reception triggering motion may alternatively be predefined as other arbitrary motions, as long as the target apparatus is located within the visible range of signals of the primary apparatus when the motions are stopped.

The exemplary data transmission method and apparatus according to the present invention may also be applied to hand-held electronic apparatuses.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A data transmission method based on motion identification, the method comprising:
detecting and identifying a change of a position status of a data transmission apparatus;
detecting, by the data transmission apparatus, a target apparatus, when the change of the position status is determined to be a predefined motion; and
establishing, by the data transmission apparatus, a connection with the target apparatus and performing, by the data transmission apparatus, a data transmission, if the target apparatus is detected.

2. The method of claim 1, wherein the predefined motion comprises a data sending triggering motion or a data reception triggering motion.

3. The method of claim 2, wherein the data sending triggering motion comprises using the transmission apparatus to describe a circle in a first predetermined direction, and the data reception triggering motion comprises using the transmission apparatus to describe a circle in a direction opposite to the first predetermined direction.

4. The method of claim 2, wherein the data sending triggering motion comprises changing the data transmission apparatus from a substantially vertical orientation into a substantially horizontal orientation, and the data reception triggering motion comprises changing the data transmission apparatus from an inverted substantially vertical orientation into the substantially horizontal orientation.

5. The method of claim 2, wherein the data sending triggering motion comprises horizontally moving the transmission apparatus in a second predetermined direction, and the data reception triggering motion comprises horizontally moving the transmission apparatus in a direction opposite to the second predetermined direction.

6. The method of claim 1, wherein a target apparatus detection unit detects the target apparatus by broadcasting an apparatus identification request toward specific directions and receiving a signal fed back from the target apparatus.

7. The method of claim 6, wherein the apparatus identification request comprises a wireless signal comprising a high directionality.

8. The method of claim 7, wherein the apparatus identification request comprises an Infrared Data Association (IrDA) infrared signal or a millimeter wave signal of 60 gigahertz (GHz).

9. The method of claim 1, wherein, when the data transmission apparatus receives an apparatus identification request of another data transmission apparatus, the data transmission apparatus sends a feedback signal to the other data transmission apparatus.

10. A data transmission apparatus based on motion identification, the apparatus comprising:
a motion sensing and identification unit for detecting and identifying a change of a position status of the apparatus;
a target apparatus detection unit for detecting a target apparatus, when the change of the position status is determined to be a predefined motion; and
a data transmission unit for establishing a connection with the target apparatus and for performing a data transmission, if the target apparatus detection unit detects the target apparatus.

11. The apparatus of claim 10, wherein the predefined motion comprises a data sending triggering motion or a data reception triggering motion.

12. The apparatus of claim 11, wherein the data sending triggering motion comprises using the transmission apparatus to describe a circle in a first predetermined direction, and the data reception triggering motion comprises using the transmission apparatus to describe a circle in a direction opposite to the first predetermined direction.

13. The apparatus of claim 11, wherein the data sending triggering motion comprises changing the data transmission apparatus from a substantially vertical orientation into a substantially horizontal orientation, and the data reception triggering motion comprises changing the data transmission apparatus from an inverted substantially vertical orientation into the substantially horizontal orientation.

14. The apparatus of claim 11, wherein the data sending triggering motion comprises horizontally moving the transmission apparatus in a second predetermined direction, and the data reception triggering motion comprises horizontally moving the transmission apparatus in a direction opposite to the second predetermined direction.

15. The apparatus of claim 10, wherein the target apparatus detection unit detects the target apparatus by broadcasting an apparatus identification request toward specific directions and receiving a signal fed back from the target apparatus.

16. The apparatus of claim 15, wherein the apparatus identification request comprises a wireless signal comprising a high directionality.

17. The apparatus of claim 16, wherein the apparatus identification request comprises an Infrared Data Association (IrDA) infrared signal or a millimeter wave signal of 60 gigahertz (GHz).

18. The apparatus of claim 10, wherein, when the data transmission apparatus receives an apparatus identification request of another data transmission apparatus, the data transmission apparatus sends a feedback signal to the other data transmission apparatus.
